(19) United States
(12) Patent Application Publication
(10) Pub. No.: US 2003/0072462 A1
(43) Pub. Date: Apr. 17, 2003

(54) Loudspeaker with large displacement motional feedback

(76) Inventor: Stefan R. Hlibowicki, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/270,132

(22) Filed: Oct. 15, 2002

Related U.S. Application Data
(60) Provisional application No. 60/329,350, filed on Oct. 16, 2001.

(51) Int. Cl. H04R 3/00

(52) U.S. Cl. 381/96

(57) ABSTRACT

The present invention relates to a distortion reduction system and method for reducing an acoustic distortion in an loudspeaker. The invention involves: a) generating a first sensor signal based on longitudinal displacement of the voice coil from the initial rest position; b) generating a second sensor signal based on longitudinal acceleration of the voice coil; c) processing and combining the first sensor signal and the second sensor signal to generate a feedback control signal; and d) adjusting an audio drive signal supplied to the voice coil to generate the acoustic waveform wherein the audio drive signal is adjusted based on the first feedback control signal.

### FIELD OF THE INVENTION

The present invention relates to a feedback system for distortion reduction in loudspeakers. More particularly, it relates to a method and apparatus for sensing and controlling the cone movement of a speaker by sensing acceleration and position.

### BACKGROUND OF THE INVENTION

The construction and operation of electro-dynamic loudspeakers are well known. The physical limitations in their construction are one cause of non-linear distortion, which is sensible in the generated sound reproduction. Distortion is particularly high at low frequencies, in relatively small sealed box constructions where cone displacement or excursions are at their maximum limit.

In the past there have been numerous approaches taken in order to reduce speaker distortion. None of these approaches addresses the problem of cone offset.

Accordingly, there is a need for a system simultaneously capable of providing increased distortion reduction and reducing non-linearity related distortions that result from large speaker cone displacements.

### SUMMARY OF THE INVENTION

An object of an aspect of the present invention is to provide an improved distortion reduction system for reducing an acoustic distortion in a waveform generated by a voice coil of an audio speaker.

In accordance with this aspect of the present invention, there is provided a distortion reduction system for reducing a distortion in an acoustic waveform generated by a voice coil of an audio speaker, wherein an audio drive signal is supplied to the voice coil and the voice coil is longitudinally movable from an initial rest position to generate the acoustic waveform. The distortion reduction system comprises: a) a position sensor for generating a first sensor signal based on longitudinal displacement of the voice coil from the initial rest position; b) an acceleration sensor for generating a second sensor signal based on longitudinal acceleration of the voice coil; c) a feedback circuit for processing and combining the first sensor signal and the second sensor signal to generate a feedback control signal; and, d) a first audio drive signal adjustment means for receiving a first input audio signal and transmitting a first output signal derived from the first input audio signal and the feedback control signal, the audio drive signal being derived from the first output signal.

An object of a second aspect of the present invention is to provide a method for reducing a distortion in an acoustic waveform generated by a voice coil of an audio speaker.

In accordance with this second aspect of the present invention, there is provided a method of reducing an acoustic distortion in the waveform generated by a voice coil of an electro-dynamic loudspeaker. The method comprises: a) generating a first sensor signal based on longitudinal displacement of the voice coil from the initial rest position; b) generating a second sensor signal based on longitudinal acceleration of the voice coil; c) processing and combining the first sensor signal and the second sensor signal to generate a feedback control signal; and d) adjusting an audio drive signal supplied to the voice coil to generate the acoustic waveform wherein the audio drive signal is adjusted based on the first feedback control signal.

### BRIEF DESCRIPTION OF THE DRAWINGS

For a better understanding of the present invention and to show more clearly how it may be carried into effect, reference will now be made, by way of example, to the accompanying drawings, which show preferred embodiments of the present invention, and in which:

FIG. 1 illustrates a schematic diagram of a loudspeaker with a motional feedback system for reducing non-linear distortion in an audio loudspeaker;

FIG. 2 is a schematic diagram of the motional feedback system shown in FIG. 1, wherein a positional sensor and acceleration sensor feedback network is illustrated in accordance with the present invention;

FIG. 3 is a circuit diagram of the positional sensor feedback network shown in FIG. 2;

FIG. 4 illustrates a perspective side view of a first embodiment of a position sensor in accordance with the present invention;

FIG. 5 illustrates a perspective side view of an alternative embodiment of the position sensor shown in FIG. 4;

FIG. 6 illustrates a schematic diagram of an electrical sensor circuit used in collaboration with the position sensor shown in FIG. 5; and

FIG. 7 illustrates a cross section view of the mechanical construction of the speaker device and the relative position of the acceleration sensor and position sensor.

### DETAILED DESCRIPTION OF THE INVENTION

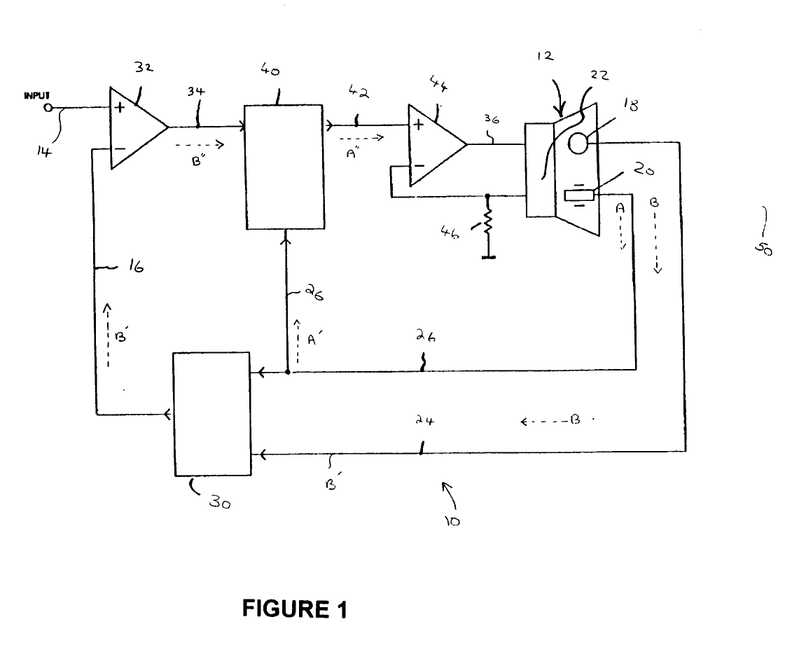

FIG. 1 illustrates a motional feedback system 10 in accordance with the present invention, wherein a plurality of sensor devices are used in collaboration with a feedback control circuit. The feedback control circuit senses and controls the longitudinal motion or movement of a voice coil 22 of a loudspeaker 12. Distortions which undesirably influence the longitudinal motion of the loudspeaker 12 in a manner which causes it to not to correspond an input audio signal 14 will be sensed. Once sensed, the distortion is accordingly compensated by a first feedback control signal 16.

In accordance with the present invention, an acceleration sensor device 18 and a position sensor device 20 are used to convert the physical movement of the loudspeaker voice coil 22 (not shown in detail in FIG. 1) into respective first and second electrical sensor signals 24 and 26. The electrical sensor signals 24, 26 output from acceleration sensor device 18 and position sensor device 20 are combined by a first feedback network 30, which generates the first feedback control signal 16. Audio input signal 14 may typically be received from an audio source such as an audio amplifier. An error amplifier 32 (which may, for example, be a differential amplifier) receives both the audio input signal 14 and the first feedback control signal 16 and generates a differential voltage signal 34. If the loudspeaker 12 exhibits any motional distortion, the electrical signals 24, 26 from the sensors 18, 20 will contain a corresponding distortion component. The distortion components on signals 24, 26 is also present in the first feedback control signal 16, which is then subtracted from the audio input signal 14 by means of error amplifier 32. As a result, the differential voltage signal 34 includes the audio input signal 14 minus the sensed distortion component in first feedback control signal 16. By subtracting this distortion component from the audio input signal 14 the distortion added by the motion of the speaker is reduced.

The loudspeaker voice coil 22 position correlates with the audio input signal 14 and the audio current drive signal 36 output from power amplifier 44. Power amplifier 44 uses current sensing resistor 46 to operate as a current amplifier for driving the voice coil. Therefore, in accordance with the present invention, a first feedback control circuit, indicated along the path B to B″ via B′, comprises the first feedback network 30, the acceleration sensor device 18 and the position sensor device 20. This first feedback control circuit, indicated along the path B to B″ via B′, senses and compensates for any such sensed distortion in the longitudinal motional displacement of the loudspeaker voice coil 22. In this way, for large speaker cone displacements needed for good bass reproduction in small box constructions, distortion is reduced.

A second feedback network 40 receives the first electrical sensor signal 26 from the position sensor device 20 and generates a second feedback control signal 42. The second feedback control signal 42 compensates for the inherent non-linearity in the loudspeaker 12 motor (not shown), wherein the motor comprises a speaker magnet and voice coil. This non-linearity, which contributes substantially to loudspeaker distortion is known in the art of speaker design. As the voice coil experiences large excursions, its position is displaced relative to its region of maximum magnetic density (i.e. optimum operating region). Therefore, the voice coil and attached speaker cone generate less force for the same current flowing through voice coil windings. This non-linear behavior, which leads to distortion in the loudspeaker 12 acoustic output waveform 50, becomes more apparent with large voice coil displacement. A second feedback circuit, indicated along the path from A to A″ via A′, and comprising the second feedback network 40 and position sensor device 20, senses and compensates for this distortion. As illustrated in FIG. 1, the differential voltage signal 34 is received as an input to the second feedback network 40. Although the differential voltage signal includes distortion compensation from the first feedback network 30, it is further processed by the second feedback network 40 in order to compensate for motor non-linear distortion.

The motional feedback system 10 illustrated in FIG. 1 is a distortion reduction system comprising the first and second feedback control circuit, wherein the first feedback control circuit utilizes two sensors 18, 20 (acceleration and position). Within any feedback control system, the bandwidth over which stable feedback is provided is of paramount importance. This, in effect, dictates the stability of the feedback circuit. The combination of the position sensor device 20 and the acceleration sensor device 18 enables the first feedback control circuit, indicated along the path B-B′-B″, to provide distortion corrective control over a selected frequency range (which will typically be selected to correspond to the frequency range of the loudspeaker) without the need for complex phase/gain compensation circuitry. The position sensor device 20 has a low pass filter characteristic ranging from DC to a cut off frequency a little over the loudspeaker resonance frequency. Hence, it has a flat gain response over this frequency range. The position sensor device 20 is not forced to operate above its cut off frequency, as the acceleration sensor takes over at frequencies above the loudspeaker resonance frequency. The acceleration sensor device has a high pass filter response up to frequencies above the speaker breakup mode frequencies. Therefore, the combination of high pass and low pass filter response in the first feedback control loop, indicated along the path B-B′-B″, provides a flat characteristic response (constant phase and gain) over the entire operating range of the loudspeaker 12. Consequently, the feedback control circuit does not require compensation circuitry that will introduce additional noise to the loudspeaker 12.

The bandwidth of a single sensor used within a control feedback loop is limited and requires a compensating network that extends its bandwidth. However, the compensating network cannot recover certain components from the feedback signal. For example, information about cone position does not exist at the output of an accelerometer or velocity sensor device. Also, the compensation network will contribute additional noise to the feedback signal and hence to the audio drive signal applied to the voice coil.

In order to generate a feedback loop with a constant gain/phase relationship over the entire operating range of the loudspeaker and to avoid the associated problems with compensation networks, the first electrical sensor signal 24 and the second electrical sensor signal 26 are combined by the first feedback network 30. Feedback network 30 combines these signals 24, 26 in order to generate a feedback transfer function of unity, where the gain and phase of the signals between the input and output of the network 30 are constant over the entire operating frequency range of the loudspeaker 12. The design of the feedback network 30 is supported with the aid of the following mathematical analysis.

The cone acceleration A(s) or generated sound pressure for a speaker in a sealed box is given by equation (1)

$$A ( s ) = \frac{{( s / Ω )}^{2}}{1 + ( s / Ω ) / Q + {( s / Ω )}^{2}} * a \qquad ( 1 )$$

where s is a Laplace variable, Ω is the angular resonance frequency in the speaker box, Q is the Q factor and a is a constant.

Similarly, cone displacement can be represented by equation (2)

$$X ( s ) = \frac{1}{1 + ( s / Ω ) / Q + {( s / Ω )}^{2}} * d \qquad ( 2 )$$

where s is a Laplace variable, Ω is the angular resonance frequency in the box, Q is the Q factor and d is a constant.

From equations (1) and (2) it can be determined that cone acceleration has a second order high-pass filter response whilst cone displacement has a second order low-pass filter response.

Equations (3) and (4) represent a first order high-pass and low-pass filter response, respectively.

$$\begin{matrix}HP ( s ) = \frac{s / Ω}{1 + ( s / Ω )} & ( 3 ) \\ LP ( s ) = \frac{1}{1 + ( s / Ω )} & ( 4 )\end{matrix}$$

Where s is a Laplace variable, Ω is the angular resonance frequency in the speaker box and Q is the Q factor.

The characteristic response of the acceleration and position sensors given by equations (1) and (2) can be combined with the characteristic response of a first order high-pass and low-pass filter, given by equations (3) and (4). By combining these equations, the desired flat response in the first feedback loop is realized (indicated along path B-B′-B″ of FIG. 1). This response is generated by combining equation (1), (2), (3) and (4) using the following relationship:

$$T ( s ) = \frac{X ( s )}{d} + \frac{A ( s )}{a} + HP ( s ) * \frac{X ( s )}{d \cdot Q} + LP ( s ) * \frac{A ( s )}{a \cdot Q} \qquad ( 5 )$$

Substituting equations (1)-(4) into equation (5) leads to equation (6):

T(s)=1 (6)

Consequently, by combining the characteristic response of the high-pass filter, low-pass filter, position sensor device and acceleration sensor device according to equation (5), the desired transfer function necessary for having a stable feedback control loop over the full bandwidth of the loudspeaker is generated.

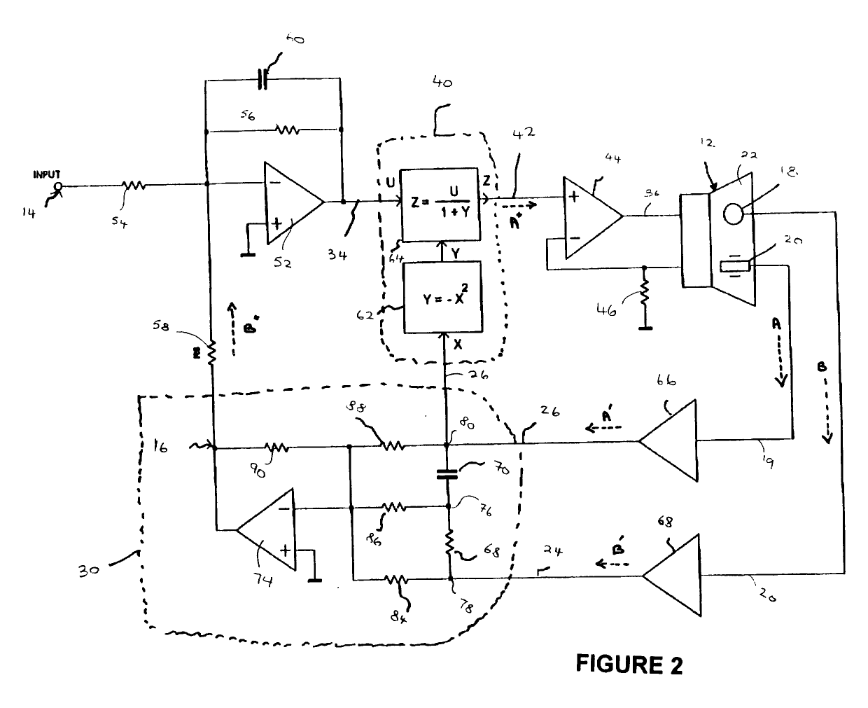

FIG. 2 provides a more detailed illustration of the motional feedback system shown in FIG. 1. The input audio signal 14 is applied to a summing amplifier 52, where the summing amplifier 52 includes resistors 54, 56, 58 and capacitor 60. Capacitor 60, connected in parallel to resistor 56, provides low-pass filtering, where the cut off frequency is selected to be below the loudspeaker breakup mode frequencies. Appropriate selection of capacitor 60 and resistor 56 satisfies this criteria and avoids any instability caused by these breakup mode frequencies. The second input to the summing amplifier is received from the first feedback control signal 16. This feedback signal 16 is 180 degrees inverted with respect to the audio input 14. Therefore, the summing amplifier 52 operates in the same manner as error amplifier 32 (FIG. 1).

The generated differential voltage signal 34 is received by the second feedback network 40, wherein the differential voltage signal 34 which is input to the network 40 at U. As previously mentioned, network 40 provides distortion compensation for inherent motor distortion which occurs as a result of large voice coil (and speaker cone) motional displacement (or excursions). The force generated by the voice coil is given by equation (7):

F=Bl(X)·I(7)

where Bl(X) is the product of magnetic flux (B) generated by the magnet and length of wire (I) in the voice coil, as a function of the voice coil position X. The voice coil position X is the position of the voice coil relative to its rest position, where X=0. Also, I in equation (7) is the current flowing through the voice coil. Ideally, a speaker should have a constant Bl(X). Satisfying this condition requires a large magnet assembly, which is typically quite expensive. As a result of the use of less than ideal magnet assemblies in practice, Bl(X) may drop to approximately 50% of its value at the cone rest position. Therefore, Bl variations are a source of significant distortion which can be attributed to the motor of a speaker device. According to equation (7), force F is proportional to voice coil current and not the voltage present at the speaker input. Using a power amplifier 44 in current mode therefore simplifies the circuitry for compensating the Bl(X) changes.

In practice, the Bl(X) function can be approximated by equation (8):

Bl(X)=Bl(0)·(1=31 k·X²) (8)

where Bl(0) is the B product when the voice coil is in the rest position and k is a constant. From equation (8) it can be deduced that as the voice coil departs from its rest position (i.e. X>0), the Bl(X) product decreases. Based on equation (8), it is possible to provide a feedback network that compensates for the reduction in Bl(X) due to the (1−kX²) factor. Therefore, the feedback network must have a transfer function of 1(1−kX²) in order to cancel the effect of the (1−kX²) factor. For this reason, in accordance with the present invention, the second feedback network 40 has a characteristic response of:

$$Z = \frac{U}{1 - k \cdot {X}^{2}} \qquad ( 9 )$$

where U is the input to the second feedback network 40, X is the voice coil position and Z is the output from the second feedback network 40.

The second feedback network 40 has two main process stages. The first process stage 62 processes the first electrical sensor signal indicative of the voice coil position X by squaring (X²) and inverting (−X²) it. It will also be appreciated that the amplitude of the first electrical sensor signal 19 is increased by amplifier 66 prior to being received by the first process stage 62. The second process stage 64 further processes the output Y=(−X²) from the first process stage 62 by combining it with the input differential voltage signal U 34 according to equation (9). The output Z from the second process stage 64 generates the second feedback control signal 42 which reduces the non-linear distortion caused by the motor. This signal 42 is a distortion compensated electrical audio signal, which is received and amplified by power amplifier 44. That is, the signal 42 is distorted or modified in a way that compensates for subsequent distortion, such that the modification and subsequent distortion cancel out. Using the current sensing resistor 46, power amplifier 44 generates the audio current drive signal 36 which drives the voice coil of the loudspeaker 12. Hence, the second feedback loop, indicated along path A-A′-A″, provides non-linear motor distortion compensation for the loudspeaker 12. Therefore, the second feedback control loop and second feedback network 40 servo the speaker voice coil so it predominantly moves or undergoes excursions in an optimum operating region centered about its rest position. By making sure that the voice coil movement region is centered about the rest position (X≈0), the effect of reduced voice coil force as a function of voice coil position X in relation to the rest position is greatly reduced.

As previously discussed, by combining the characteristic response of a first order high-pass filter, first order low-pass filter, position sensor 20 and acceleration sensor 18 according to equation (5), the desired transfer function necessary for having a stable feedback control loop over the full bandwidth of the loudspeaker 12 is realized. As shown in FIG. 2, this is achieved by adding the first feedback network 30 into the first feedback loop, indicated along path B-B′-B″. Both the first and second electrical sensor signals output from the position sensor 18 and acceleration sensor 20 are amplified by amplifier 66 and 68 respectively. The amplified first electrical sensor signal (acceleration sensor 18 output) 24 is filtered by a first order low pass filter comprising resistor 68 and capacitor 70 prior to being received by input 76 of a summing amplifier circuit. The summing amplifier circuit comprises summing amplifier 74, input resistors 84, 86 and 88, and feedback resistor 90. Similarly, the amplified second electrical sensor signal (position sensor 20 output) 26 is filtered by a first order high pass filter comprising capacitor 70 and resistor 68 prior to also being received by input 76 of the summing amplifier circuit. The values of capacitor 70 and resistor 68 must satisfy equation (10):

$$Resistor 68 \cdot Capacitor 70 = \frac{1}{Ω} \qquad ( 10 )$$

where Ω is the angular resonance frequency of the speaker box (2πfᵣ).

The amplified first electrical sensor signal 24 (acceleration sensor 18 output) is directly received (i.e. not filtered) by input 78 of the summing amplifier circuit. Also, the amplified second electrical sensor signal (acceleration sensor 18 output) 26 is directly received (i.e. not filtered) by input 80 of the summing amplifier circuit. The output of this summing amplifier circuit 16 generates an amplified sum of the electrical signals present at inputs 76, 78 and 80.

It will be appreciated that the electrical signals present at each of these inputs 76, 78, 80 represents each term in equation (5), where the term:

$$HP ( s ) * \frac{X ( s )}{d \cdot Q} + LP ( s ) * \frac{A ( s )}{a \cdot Q}$$

is realized by combining the low-pass filtered first electrical sensor signal (acceleration sensor output 18) and the high-pass filtered second electrical sensor signal (position sensor output 20) at input 76 of the summing amplifier circuit. Similarly, terms:

$$\frac{X ( s )}{d} and \frac{A ( s )}{a}$$

represent the amplified first electrical sensor signal (acceleration sensor 18 output) 24 and the amplified second electrical sensor signal (position sensor 20 output) 26 received by inputs 78 and 80. Consequently, the first feedback control signal 16 output from the summing amplifier circuit is the amplified sum of all the terms presented in equation (5). This shows that the network 30 generates an output 16 which has the same transfer characteristics as equation (5), where T(s)=1. Hence, first feedback control signal 16 has a flat amplitude and phase response, which enables a high feedback loop gain. It will be appreciated that resistor 86 must be Q times larger than the value of resistor 88 and 84. This condition must hold in order for T(s) to be unity and therefore be frequency independent. The reason for this scaling factor is that a combined signal is received by resistor 86, and therefore, in order to compensate for receiving this combined signal, resistor 86 is chosen to be Q times larger than resistor 88 and 84.

The high feedback loop gain in turn increases the sensitivity of the feedback system, which increases its motion-dependent distortion reduction capability. Therefore, in accordance with the present invention, a motional feedback system in proposed, which is capable of providing enhanced distortion reduction over the entire operating frequency range of the loudspeaker. Consequently, the motional feedback system is a feedback circuit, which includes a first and second feedback circuit. The first feedback circuit reduces motion dependent distortions due to physical speaker construction limitations, whilst the second feedback system reduces motion dependent distortion introduced by the loudspeaker motor.

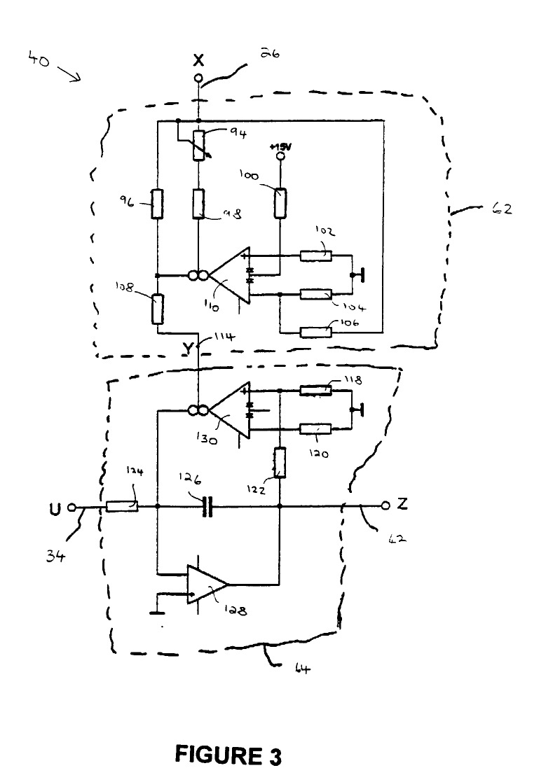

FIG. 3 illustrates a schematic diagram for the electrical circuit of the second feedback network 40. The first process stage 62 is an analogue multiplier circuit, which includes resistor components 94, 96, 98, 100, 102, 104, 106, 108 and transconductance amplifier (which may be an LM13700 transconductance amplifier or another transconductance amplifier) 110. The amplified second electrical sensor signal 26 is received by the analogue multiplier circuit, and generates an output signal Y, indicated at 114. The generated output signal Y is proportional to the square of the received signal, indicated at 26, where

Y=−kX²

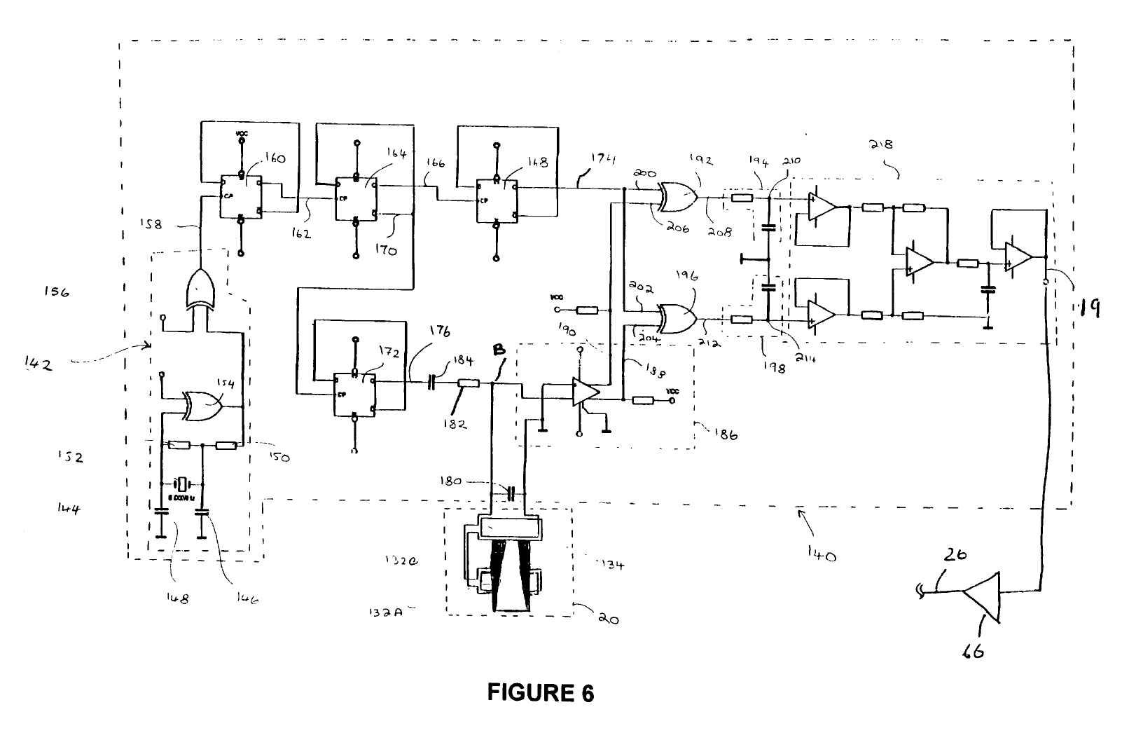

In this equation, k is a constant and X is a position control signal received from the output of a position sensor circuit (see FIG. 6). The position sensor circuit includes position sensor 20 and an electrical sensor circuit 140 (FIG. 6), wherein the sensor circuit 140 processes the output from the position sensor 20 and generates the position control signal 19. It will be appreciated that the position control signal 26 of FIG. 6 is the same as the second electrical sensor signal 26 of FIGS. 1 and 2.

The output signal Y 114 from the first process stage 62 is received by the second process stage 64. The second process stage 64 is a voltage controlled amplifier (VCA) circuit which includes resistor components 118, 120, 122, and 124, capacitor component 126, operational amplifier 128 and transconductance amplifier 130. Output signal Y 114 is received by the bias input of transconductance amplifier 130, whilst the differential voltage signal U 34 is input to resistor 124. The resulting output signal Z 42 from the second process stage 64 is given by equation (11).

$$Z = \frac{U}{1 - k \cdot {X}^{2}} \qquad ( 11 )$$

Where X is the position control signal 26, k is a constant and U is the differential voltage signal 34. For example, if the voice coil is operating about its ‘optimum operating point’ (centered about the rest position), the position control signal X will be approximately 0 V and no signal compensation is provided at the output Z of the second feedback circuit 40. The polarity of the position control signal X 34 depends on the direction in which the voice coil has departed from the ‘optimum operating point’.

Consequently, the output from the second process stage 64, which is the output from the second feedback network 40, compensates for non-linear distortion in the motor. Although term 1−kX² does not model the speaker motor perfectly, in practice, the second feedback control loop (path A-A′-A″ shown in FIGS. 1 and 2) and second feedback network 40 reduce distortion substantially. The remaining distortion elements are further reduced by the first feedback control loop (path B-B′-B″ shown in FIGS. 1 and 2) and first feedback network 30.

The design steps involved in realizing the functionality of the analogue multiplier 62 and VCA circuit 64 can typically be determined by referring to the transconductance amplifier data sheet.

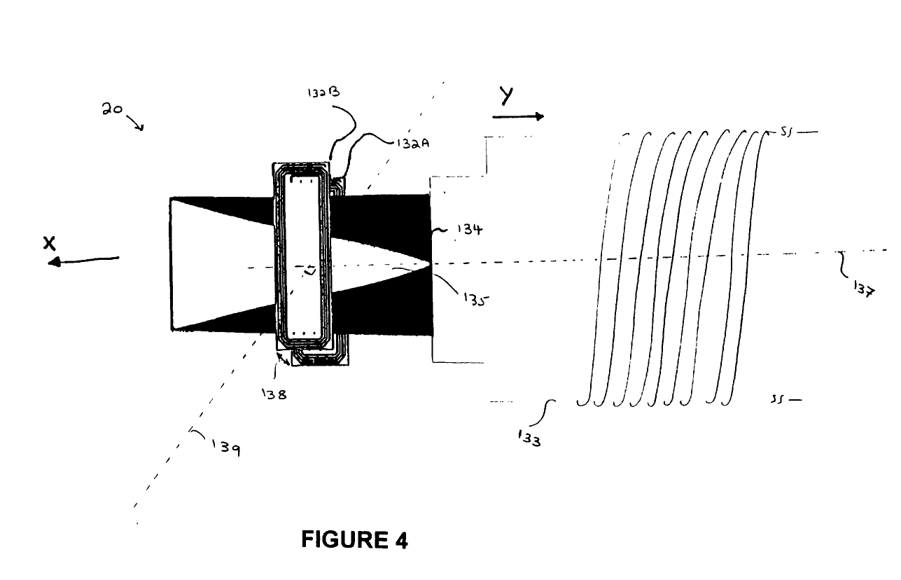

FIG. 4 illustrates the position sensor device 20, which includes a first and second inductance coil 132A, 132B and an approximately triangular shaped conductive core 134. Optionally, all of these components 132A, 132B, 134 are manufactured on printed circuit boards (PCB). Furthermore, the coils may be printed on both sides of the PCB boards and electrically connected in series in order to maximize their total inductance. The conductive region 135 of the conductive core 134 is longitudinally displaced within a finite gap region, defined by 138. As the conductive core 134 moves in the direction indicated by Arrow X, a larger amount of copper is immersed in the magnetic field generated by the coils 132A, 132B. This in turn decreases the inductance of the coils 132A, 132B. Conversely, as the conductive core 134 moves in a direction indicated by Arrow Y, a smaller amount of copper is immersed in the magnetic field generated by the coils 132A, 132B, which in turn increases the inductance of the coils 132A, 132B. The conductive core 134 is geometrically compensated in order to ensure that its longitudinal displacement (X or Y Arrow direction) in the center of the finite gap region 138 generates a linear change in the output voltage of the position sensor circuit. Hence, a linear position control signal (position sensor output 19 shown in FIG. 6) is generated as a result of this inductance change. As illustrated in FIG. 4, the shape of the conducting region 135 is not precisely triangular. It is shaped to linearize the relationship between the output voltage of the position sensor and the displacement of the core 134. Conducting region 135 has a curved shape. As illustrated in FIG. 4, in use, the first and second inductance coils 132A, 132B are stationary, whilst the conductive core 134 is attached to the bobbin of the voice coil 133. Therefore, as the voice coil longitudinally moves, the conductive core 134 is longitudinally displaced within the finite gap region 138 between the coils 132A, 132B. Hence, the inductance of the coils 132A, 132B varies in unison with voice coil movement. Although the coils 132A, 132B are stationary and the conductive core 134 moves, in an alternative embodiment, it will be appreciated that the coils 132A, 132B may be connected to the voice coil, whilst the conductive core 134 remains stationary. However, it is found that by connecting the core 134 to the voice coil, a rigid connection which generates satisfactory position sensing is provided.

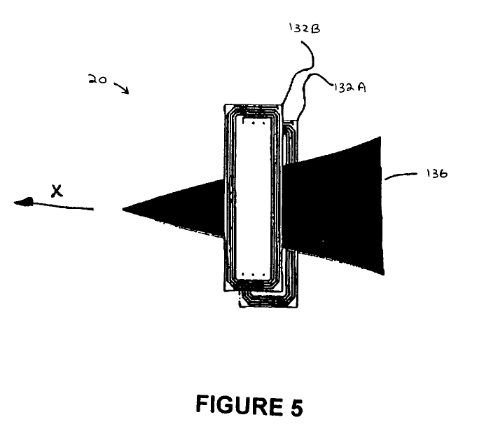

FIG. 5 shows an alternative embodiment of the position sensor 20, wherein the conductive core 136 is comprised solely of a conductive region. The operation of this sensor is essentially the same as that of the sensor described and illustrated in FIG. 4.

Referring to FIG. 4, the position sensor 20 is also positioned, such that no electrical cross talk occurs between the inductance coils 132A, 132B and the voice coil. This is achieved ensuring that the vector orientation of the magnetic field generated by the inductance coils 132A, 132B is orthogonal to the vector orientation of the magnetic field generated by the voice coil. In terms of the physical positioning of the inductance coils 132A, 132B and the voice coil, their respective axes must be orthogonal in order to eliminate electrical cross talk. This means that a concentric longitudinal axis 137, which passes concentrically through the voice coil must be orthogonal to a first axis 139 which passes through the center of both inductance coils 132A, 132B.

FIG. 6 illustrates the position sensor circuit comprising the position sensor device 20 and processing circuit 140. The circuit 140 coverts the changes in the inductance of the position sensor 20 and generates the position control signal 19 wherein the voltage magnitude of the position control signal 19 is proportional to the displacement of the core 134. Within the circuit of FIG. 6, an oscillator circuit 142 comprises a crystal (6 MHz, for example) 144, capacitor component 146, capacitor component 148, resistor component 150, resistor component 152, XOR logic gate 154 and XOR logic gate 156. This circuit 142 generates a 6 MHz squarewave signal at the output 158 of XOR gate 156. The 6 MHz squarewave signal at the output 158 of XOR gate 156 is then applied to the clock input of D-Type flip-flop 160, which divides the signal into a 3 MHz squarewave. The 3 MHz output 162 from D-Type flip-flop 160 is applied to the clock input of D-Type flip-flop 164, which further divides the signal into a 1.5 MHz squarewave signal. D-Type flip-flop 164 has two complementary outputs 166, 170, where the first output 166 generates a first 1.5 MHz squarewave, which is applied to the clock input of D-Type flip-flop 168. The second output 170 generates a second 1.5 MHz squarewave, which is 180 degrees out of phase with the a first 1.5 MHz squarewave. This signal is applied to the clock input of D-Type flip-flop 172. D-Type flip-flop 168 divides the first 1.5 MHz squarewave to a first 750 KHz squarewave signal, which is present at its output 174. Similarly, D-Type flip-flop 172 divides the second 1.5 MHz squarewave to a second 750 KHz squarewave signal, which is present at its output 176. The first and second 750 KHz squarewaves are 90 degrees out of phase as a result of being clocked by the anti-phase first and second 1.5 MHz squarewaves.

The series connected coils 132A, 132B and capacitor 180 provide a parallel resonant circuit tuned to 750 KHz when the conductive core 132 is in its center position (i.e. voice coil is in the optimum operating region). The second 750 KHz squarewave at output 176 is filtered by capacitor 184 and resistor 182, such that at point B at the terminal of resistor 182, the second 750 KHz squarewave is converted to a 750 KHz sinusoidal signal of the same phase. Provided that the triangular conductive core 132 is in its center position, the phase of the 750 KHz sinusoidal signal does not change. The 750 KHz sinusoidal signal is then re-converted back to a 750 KHz squarewave by comparator circuit 186, whereby if the phase has not been affected by the resonant circuit (i.e. core 132 is in its center position), the 750 KHz squarewave has the same phase as the signal output from D-Type flip-flop 172. Therefore, it will still have a 90-degree phase shift relative to the first 750 KHz signal generated by the output 174 of D-Type flip-flop 168: It will be appreciated however, that the comparator circuit 186 has first and second complementary outputs 188, 190 that are 180 degrees out of phase. Hence, the first output 190 will have the same 90-degree phase shift relative to the first 750 KHz signal generated by the output 174 of D-Type flip-flop 168, and the second output 188 will have a 270-degree phase shift relative to this signal (output from 174).

EXOR logic gate 192 and low pass filter network 194 form a first phase comparator circuit, whilst EXOR logic gate 196 and low pass filter network 198 form a second phase comparator circuit. The first 750 KHz signal generated by the output 174 of D-Type flip-flop 168 is applied to the first input 200, 202 of both the first and second phase comparator network, respectively. Also, the first output 190 and the second output 188 from comparator 186 are applied to the second input 206, 204 of the first and second phase comparator network, respectively.

Under these conditions, where the triangular core 134 is in the rest position, and the signals from the comparator 186 output 190 and the D-Type flip-flop 168 output 174 have a 90 degree phase difference, the first phase comparator XOR gate 192 output 208 will generate a squarewave signal with a 50% duty cycle. Therefore, the corresponding averaging applied to this signal by the low pass filter 194 will generate a DC voltage of 0 V at output 210. Similarly, when the signals from the comparator 186 complementary output 188 and the output 174 from D-Type flip-flop 168 have a 270-degree phase difference, the second phase comparator XOR gate 196 output 212 will also generate a squarewave signal with a 50% duty cycle. Accordingly, this signal is averaged through the low pass filter 198, wherein the averaged signal at output 214 is a DC voltage of approximately 0 V. Both DC outputs 210, 214 from the phase comparators are received by a differential amplifier 218, which generates a difference signal based on the DC outputs 210 and 214. This corresponding difference signal is the position control signal 26 which is also referred to as the second electrical sensor signal in the descriptions of FIGS. 1 and 2. Therefore, the position control signal 26 is 0V and the second feedback compensation network 40 does not provide any distortion compensation.

Under the conditions where the speaker voice coil movement is centered about a position offset from its center position (i.e. optimum operating region centered about rest position), the change in inductance of the position sensor 20 varies the resonance frequency of the parallel resonance circuit generated by the coils 132A, 132B and capacitor 180. This in turn causes an additional phase shift in the 750 KHz sinusoidal signal, at point B, relative to the first 750 KHz squarewave signal, which is present at the output 174 of D-Type flip-flop 168. The relative phase difference between these two signals will depart from 90-degrees (depending on direction of core 134 movement), which causes one output (e.g. 208) from one XOR gate (e.g. 192) to generate a squarewave signal with a duty cycle greater than 50%, whilst the other output (e.g. 212) from the other XOR gate (e.g. 196) generates a squarewave signal with a duty cycle less than 50%. DC averaging of the squarewave with a duty cycle greater than 50% will generate a positive DC voltage in proportion to the width of the pulses. Also, DC averaging of the squarewave with a duty cycle less than 50% will generate a lesser magnitude DC voltage in proportion to the width of the pulses. The DC voltages from the low pass filter 194, 198 outputs 210, 214 are received by the differential amplifier 218, and a corresponding position control signal is generated 19. The more the core 134 is displaced relative to its center position, the more the duty cycle of the squarewave signals is effected. Therefore, the magnitude difference between the DC voltages generated by averaging these squarewaves is increased. Hence, the position control signal 19 generated by the differential amplifier 218 increases. The generated position control signal is directly proportional to the voice coil 133 and hence the core 134 displacement (see FIG. 4). As illustrated in FIG. 2, this signal 19 is amplified, as indicated at 26, then applied (input X) to the second feedback network (pre-distortion circuit) for providing distortion compensation (for motor non-linearity).

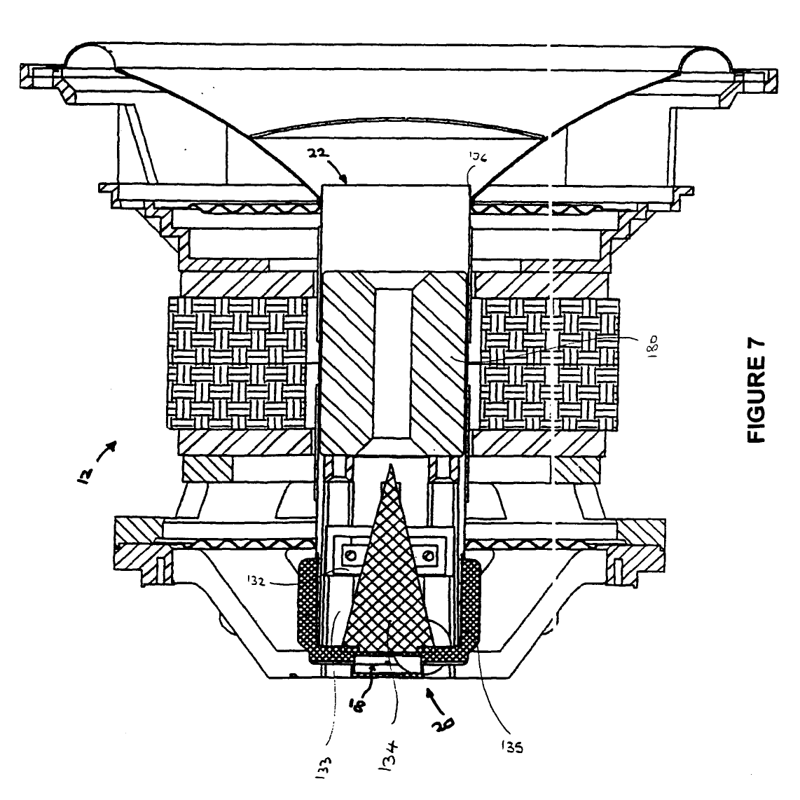

FIG. 7 illustrates the mechanical construction of the speaker device 12 and the relative position of the acceleration sensor 18 and position sensor 20. As illustrated in the FIG. 7, the acceleration sensor 18 and position sensor's triangular conductive core 134 are connected to the bottom region of the voice coil bobbin 136. The first and second inductance coils 132 (only one coil shown) are connected to a fixed (stationary) position or physical location on the speaker either side of the triangular conductive core 134. Consequently, as the voice coil moves, the triangular conductive core 134 moves within the inductance coils 132. Therefore, the position sensor generates the electrical feedback control signal (or position control signal) necessary for distortion reduction. As shown in FIG. 7, the triangular conductive core 134 is connected to the bobbin 136 by means of bracket 135. The acceleration sensor 18 also generates the electrical feedback control signal, which is linearly proportional to the movement of the voice coil 180 and bobbin 136.

The described embodiments of the present invention provide an electrical motional feedback system for reducing distortion in loudspeakers, in particular loudspeakers having small cabinet or box sizes and high speaker cone excursions. It should be understood that various modifications can be made to the preferred and alternative embodiments described and illustrated herein without departing from the spirit and scope of the invention.

1. A distortion reduction system for reducing an acoustic distortion in an acoustic waveform generated by a voice coil of an audio speaker, wherein an audio drive signal is supplied to the voice coil and the voice coil is longitudinally movable from an initial rest position to generate the acoustic waveform, the distortion reduction system comprising:
a) a position sensor for generating a first sensor signal based on longitudinal displacement of the voice coil from the initial rest position;
b) an acceleration sensor for generating a second sensor signal based on longitudinal acceleration of the voice coil;
c) a feedback circuit for processing and combining the first sensor signal and the second sensor signal to generate a feedback control signal; and,
d) a first audio drive signal adjustment means for receiving a first input audio signal and transmitting a first output signal derived from the first input audio signal and the feedback control signal, the audio drive signal being derived from the first output signal.

2. The distortion reduction system as defined in claim 1 wherein the feedback circuit comprises processing means for combining a high frequency portion of the first sensor signal with a low frequency portion of the second sensor signal to provide the feedback control signal.

3. The distortion reduction system as defined in claim 1 wherein the feedback circuit comprises processing means for combining a high frequency portion of the first sensor signal, a low frequency portion of the second sensor signal, the first sensor signal and the second sensor signal to provide the feedback control signal.

4. The distortion reduction system as defined in claim 3 wherein the processing means comprises
a low pass filter for removing frequencies above the resonance frequency from the second sensor signal, and
a high pass filter for removing frequencies below the resonance frequency from the first sensor signal.

5. The distortion reduction system as defined in claim 2 wherein the first audio drive signal adjustment means is operable to subtract the feedback control signal from the first input audio signal to provide the first output signal.

6. The distortion reduction system as defined in claim 1 further comprising
a second feedback circuit for processing the first sensor signal to generate a feedback control factor for compensating for a non-linear voice coil distortion, and
second audio drive signal adjustment means for receiving a second input audio signal and transmitting a second output signal derived from the second input audio signal and the feedback control factor, the audio drive signal being derived from the second output signal.

7. The distortion reduction system as defined in claim 6 wherein
the feedback control factor is inversely proportional to the square of the longitudinal displacement of the voice coil from the initial rest position; and,
the second audio drive signal adjustment means is operable to multiply the second input audio signal by the feedback control factor to provide the second output signal.

8. The distortion reduction system as defined in claim 7 wherein the feedback control factor is equal to 1/(1−k·X²), where k is a constant and X is the longitudinal displacement of the voice coil from the initial rest position.

9. The distortion reduction system as defined in claim 7 wherein the first output signal is the second input audio signal.

10. A method of reducing an acoustic distortion in the acoustic waveform generated by a voice coil of an electro-dynamic loudspeaker, the method comprising:
a) generating a first sensor signal based on longitudinal displacement of the voice coil from the initial rest position;
b) generating a second sensor signal based on longitudinal acceleration of the voice coil;
c) processing and combining the first sensor signal and the second sensor signal to generate a feedback control signal; and
d) adjusting an audio drive signal supplied to the voice coil to generate the acoustic waveform wherein the audio drive signal is adjusted based on the first feedback control signal.

11. The method as defined in claim 10 wherein step (c) comprises combining a high frequency portion of the first sensor signal with a low frequency portion of the second sensor signal to provide the feedback control signal.

12. The method as defined in claim 11 wherein step (c) further comprises combining the first sensor signal with the second sensor signal and with the combined high frequency portion of the first sensor signal and the low frequency portion of the second sensor signal to provide the feedback control signal.

13. The method as defined in claim 11 wherein step (d) comprises subtracting the feedback control signal from a first input audio signal to provide a first output signal, and deriving the audio drive signal from the first output signal.

14. The method as defined in claim 10 further comprising
processing the first sensor signal to generate a feedback control factor for compensating for a non-linear voice coil distortion, and
adjusting the audio drive signal based on the feedback control factor.

15. The method as defined in claim 14 wherein
the feedback control factor is inversely proportional to the square of the longitudinal displacement of the voice coil from the initial rest position; and,
the audio drive signal is adjusted by multiplying a second input audio signal by the feedback control factor to provide a second output signal, and then deriving the audio drive signal from the second output signal.

16. The method as defined in claim 15 wherein the feedback control factor is equal to 1/(1−k·X²), where k is a constant and X is the longitudinal displacement of the voice coil from the initial rest position.

17. The method as defined in claim 15 wherein the first output signal is the second input audio signal.

18. An electro-dynamic loudspeaker comprising:
a) a voice coil for generating an acoustic waveform, the voice coil being longitudinally movable from an initial rest position to generate the acoustic waveform; and,
b) a distortion reduction system as defined in claim 1 for reducing an acoustic distortion in the acoustic waveform generated by the voice coil.

19. An electro-dynamic loudspeaker comprising:
a) a voice coil for generating an acoustic waveform, the voice coil being longitudinally movable from an initial rest position to generate the acoustic waveform; and,
b) a distortion reduction system as defined in claim 2 for reducing an acoustic distortion in the acoustic waveform generated by the voice coil.
